(19) United States
(12) Patent Application Publication
(10) Pub. No.: US 2005/0100860 A1
(43) Pub. Date: May 12, 2005

(54) Dental instrument

(76) Inventor: Nasser Kameli, South Glastonbury, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 10/983,189

(22) Filed: Nov. 4, 2004

Related U.S. Application Data
(60) Provisional application No. 60/517,952, filed on Nov. 6, 2003.

(51) Int. Cl. A61C 3/02; A61C 3/08

(52) U.S. Cl. 433/144; 433/164; 433/142; 433/141

(57) ABSTRACT

A dental instrument includes an elongated body portion forming a handle for the instrument, the elongated body portion having a first end and a second end opposite the first end. A first extension is disposed at the first end, and a distal end of the first extension is formed into a first tool selected from one of: a plugger, a burnisher, a carver, and an explorer. A second extension is disposed at the first end, and a distal end of the second extension is formed into a second tool selected from another of: a plugger, a burnisher, a carver, and an explorer. The extensions on each end may define an included angle of between about 70 degrees to about 120 degrees A third extension may also be disposed at the first end, with a distal end of the third extension being formed into a third tool different than the first and second tools. One or more additional extensions having tools formed thereon may be disposed at the second end of the body portion. Where three extensions are formed on a single end, the extensions may be evenly spaced about the perimeter of the body portion.

### BACKGROUND OF THE INVENTION

1. Field of the Invention

This invention relates to dental instruments.

2. Description of the Related Art

In dentistry there are many instruments used by a dentists to place an amalgam or silver filling into the prepared tooth. The most common instruments have an end shaped as a tool for performing a step in the filling process. The most common tools are: (a) pluggers, which have a flat end surface for placing the amalgam into the prepared cavity; (b) burnishers, which have a protruding end surface to smooth the amalgam where it meets the tooth; (c) carvers, which are cup-shaped to shape and carve the amalgam on the tooth; and (d) explorers, which are claw-shaped to shave excess amalgam from the tooth.

Typically, dental instruments are single-ended or double-ended. In single-ended instruments, one end of the instrument is configured as a plugger, burnisher, carver, or explorer. In double-ended instruments, both ends of the instrument are configured as a plugger, burnisher, carver, or explorer. In either single-ended or double-ended instruments, each instrument typically includes only one type of tool to perform only one function. That is, the instrument performs only plugging, burnishing, carving, or exploring. As a result, the instruments must be separately handed to the dentist by an assistant, one at a time, in order to perform dental fillings.

Attempts to combine various tools into a single dental instrument have been made. For example, U.S. Pat. No. 2,696,048 describes a dental instrument having a bifurcated body element for picking up amalgam in tweezer fashion, with a variety of pluggers disposed at ends of the bifurcated body element. Also, U.S. Pat. No. 4,643,677 describes a double-ended dental instrument having a plugger element on each end, with each plugger element being bent to form a burnisher. Even with these attempts, however, additional instruments, such as instruments including carvers and explorers, must be handed to the dentist to complete the filling process.

### BRIEF SUMMARY OF THE INVENTION

The above-described and other drawbacks and deficiencies of the prior art are overcome or alleviated by a dental instrument including an elongated body portion forming a handle for the instrument, the elongated body portion having a first end and a second end opposite the first end. A first extension is disposed at the first end, and a distal end of the first extension is formed into a first tool selected from one of: a plugger, a burnisher, a carver, and an explorer. A second extension is disposed at the first end, and a distal end of the second extension is formed into a second tool selected from another of: a plugger, a burnisher, a carver, and an explorer. The first extension and the second extension may define an included angle of between about 70 degrees to about 120 degrees. A third extension may also be disposed at the first end, with a distal end of the third extension being formed into a third tool selected from one of: a plugger, a burnisher, a carver, and an explorer, the third tool being different than the first and second tools.

In other embodiments, one or more additional extensions are formed at the second end of the body portion. Each of these additional extensions has a distal end forming a tool selected from one of: a plugger, a burnisher, a carver, and an explorer.

Where three or more extensions are formed on a single end, the extensions may be evenly spaced about the perimeter of the body portion. The pluggers may have a smooth end or a serrated end. The carvers may have a pointed end or a round end, and the burnishers may have a pointed end or a round end.

The details of one or more embodiments of the invention are set forth in the accompanying drawings and the description below. Other features, objects and advantages of the invention will be apparent from the description and drawings, and from the claims.

### BRIEF DESCRIPTION OF THE DRAWINGS

The invention will be more fully understood from the following detailed description taken in conjunction with the accompanying drawings wherein like elements are numbered alike, and in which:

FIG. 1 is a side view of a double ended dental instrument including a carver formed at one end, and a plugger and burnisher formed at another end;

FIG. 2 is a side view of an alternative double-ended dental instrument including an explorer formed at one end, and a plugger and burnisher formed at another end;

FIG. 3a is side view of a single-sided dental instrument including a burnisher, plugger, and carver formed at one end;

FIG. 3b is an end view of the single-sided dental instrument of FIG. 3a;

FIG. 4a is a side view of a double-ended dental instrument including an explorer formed at one end, and a plugger, burnisher, and carver formed at another end;

FIG. 4b is an end view of the double-ended dental instrument of FIG. 4a;

FIG. 5a is a side view of a serrated plugger;

FIG. 5b is a side view of a smooth plugger;

FIG. 5c is a side perspective view of a round carver;

FIG. 5d is a side perspective view of a pointed carver;

FIG. 5e is a side view of a ball burnisher; and

FIG. 5f is a side view of a pointed burnisher.

### DETAILED DESCRIPTION

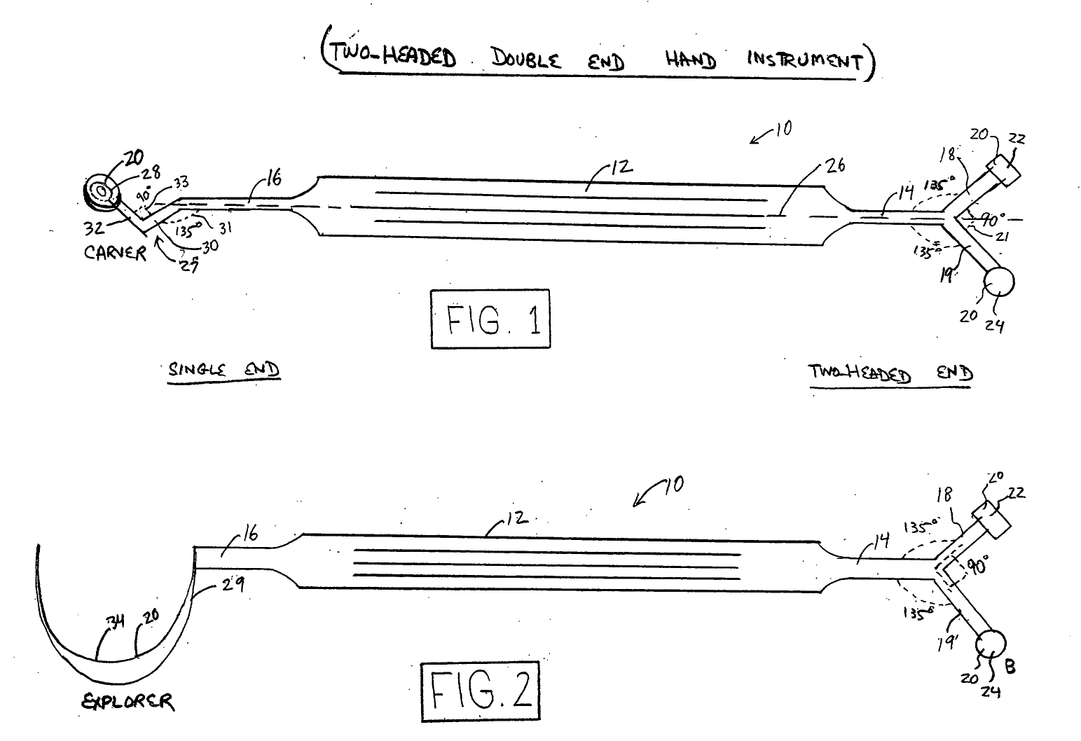

Referring to FIG. 1, a dental instrument 10 including an elongated body portion 12 forming a handle for the instrument 10 is shown. The elongated body portion 12 has a first end 14 and a second end 16 opposite the first end. A first extension 18 is disposed at the first end 14, and a distal end of the first extension 18 is formed into a first tool 20, which is depicted as a plugger 22. A second extension 19 is disposed at the first end 14, and a distal end of the second extension 19 is formed into a second tool 20, which is depicted as a burnisher 24. The first extension 18 and the second extension 19 define an included angle 21, which is preferably between about 70 degrees to about 120 degrees, and more preferably between about 80 degrees to about 100 degrees, with about 90 degrees being most preferred. Preferably, an axis 26 of the elongated body portion 12 bisects the included angle 21. Because the dental instrument 10 includes different tools 20 at the first end 14 (e.g., a plugger and a burnisher), the dentist can use the instrument 10 to perform two different functions simply by rotating the dental instrument 10 about its axis 26, without removing the instrument 10 from the patient's mouth.

A third extension 27 is disposed at the second end 16, with a distal end of the third extension 27 being formed into a third tool 20, which is depicted as a carver 28. The third extension 27 includes a first portion 30 defining a first included angle 31 with the axis 26 of the elongated body portion 12, and a second portion 32 defining a second included angle 33 with the first portion 30. The first included angle 31 is preferably between about 115 degrees to about 155 degrees, and more preferably between about 125 degrees to about 145 degrees, with about 135 degrees being most preferred. The second included angle 33 is preferably between about 70 degrees to about 110 degrees, and more preferably between about 80 degrees to about 100 degrees, with about 90 degrees being most preferred. The angled design of the third extension 27 allows the carver 28 to be easily manipulated in the patient's mouth. The use of a tool 20 on the second end 16 allows the dentist to perform a third function (e.g., carving) without having to retrieve a different dental instrument.

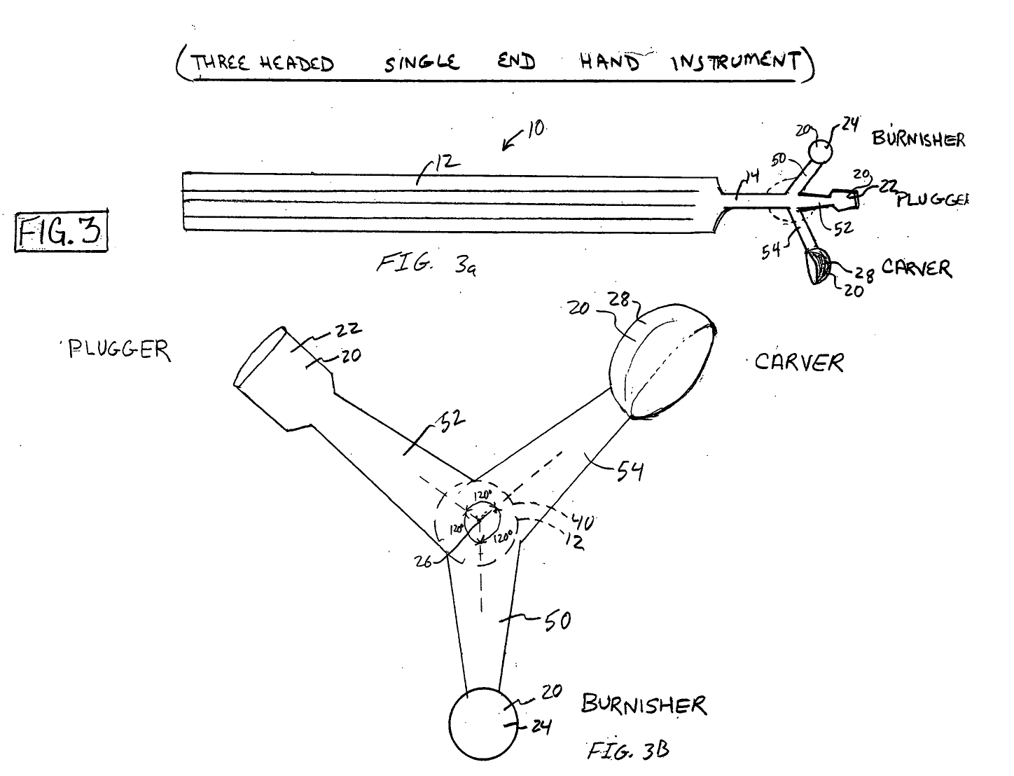

While the tools 20 provided on the dental instrument 10 of FIG. 1 include a plugger 22 and a burnisher 24 at the first end 14 and a carver 28 at the second end 16, it is contemplated that other tools 20 may be used. For example, FIG. 2 shows a dental instrument 10 including an explorer 34 formed on an extension 29 disposed at the second end 16. Also, additional tools 20 may be added to provide two or more different tools 20 at one or both of ends 14 and 16. For example, FIG. 3 shows a dental instrument 10 including three separate extensions 50, 52, and 54 extending from the first end 14 of the body portion 12, with a tool 20 being formed on each of the three extensions 50, 52 and 54. In the embodiment of FIG. 3, the tools 20 include a burnisher 24, a carver 28, and a plugger 22. FIG. 3a is a side view of the dental instrument 10 and FIG. 3b is an end view of the dental instrument 10. As shown in FIG. 3b, the different extensions 50, 52 and 54 are spaced evenly about a perimeter 40 of the body portion 12, forming an angle of about 120 degrees between adjacent extensions 50, 52 and 54 when viewed in a plane perpendicular to the axis 26.

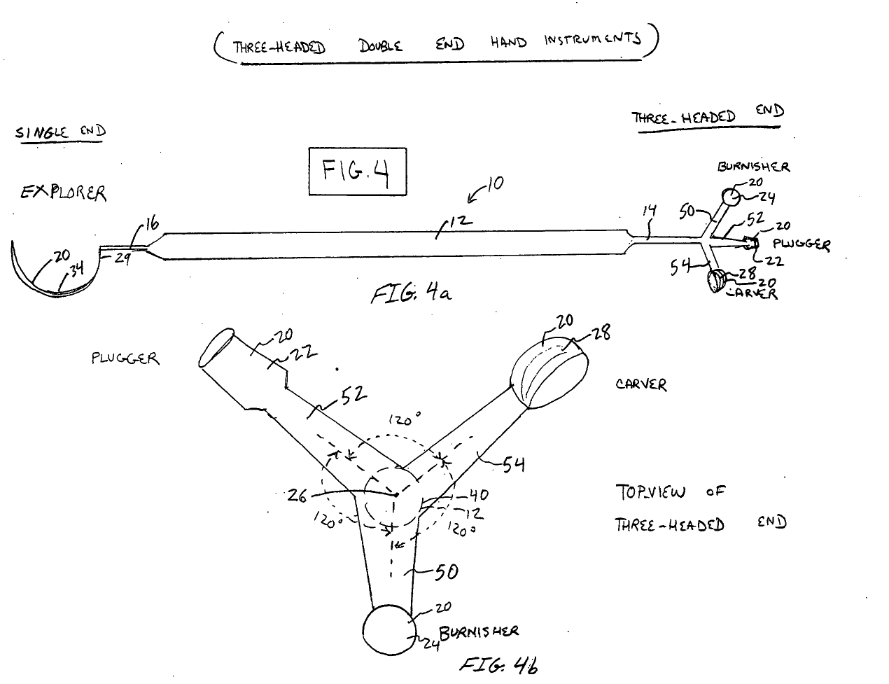

FIG. 4 shows a dental instrument 10 including three tools 20 formed on extensions 50, 52 and 54 disposed at the first end 14 of the body portion 12, and another tool 20 formed on an extension 29 disposed at the second end 16. In the embodiment of FIG. 4, the instrument 10 includes an explorer 34 formed at the second end 16, and a plugger 22, burnisher 24, and carver 28 formed at the first end 14. FIG. 4a is a side view of the dental instrument 10, and FIG. 4b is an end view of the dental instrument 10. As shown in FIG. 4b, the different extensions 50, 52, and 54 are spaced evenly about the perimeter 40 of the body portion 12.

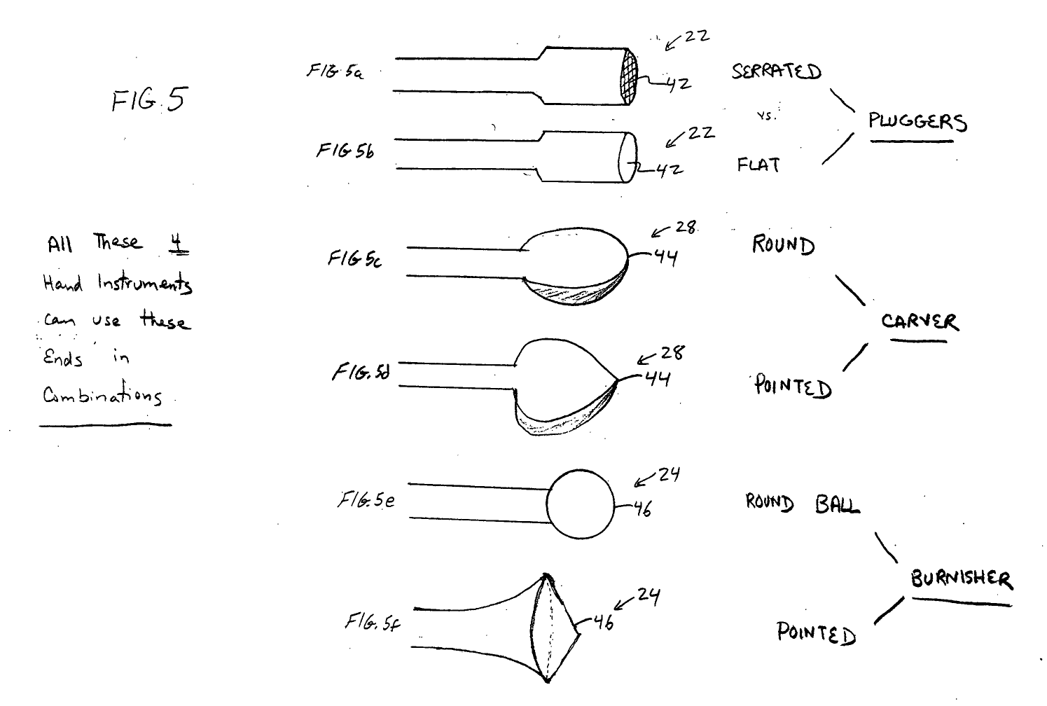

FIGS. 5a and 5b depict two different types of pluggers 22. A plugger 22 is a tool having a flat end surface 42 that may be used for placing amalgam into a prepared cavity. The end surface 42 may be serrated, as depicted in FIG. 5a, or may be smooth, as depicted in FIG. 5b. Either type of plugger 22 may be used in any of the embodiments described herein.

FIGS. 5c and 5d depict two different types of carvers 28. A carver 28 is a cup-shaped tool that may be used to carve the amalgam on the tooth. The tip 44 of the carver 28 may be round, as depicted in FIG. 5c, or may be smooth, as depicted in FIG. 5d. Either type of carver 28 may be used in any of the embodiments described herein.

FIGS. 5e and 5f depict two different types of burnishers 24. A burnisher 24 is a tool having a protruding end surface 46 that may be used to smooth the amalgam where it meets the tooth. The end surface 46 may be shaped as a ball, as depicted in FIG. 5e, or may be shaped as a point, as depicted in FIG. 5f. Either type of burnisher 24 may be used in any of the embodiments described herein.

The dental instrument of the present invention provides two or more different types of tools at a single end of the dental instrument, which allows a dentist to perform two or more different functions in the filling process simply by rotating the dental instrument about its axis, without removing the instrument from the patient's mouth. The dental instrument may also provide one or more additional tools disposed at the opposite end of the body portion, allowing the instrument to be flipped for providing additional functionality. With the dental instrument of the present invention, the dentist can perform the filling process while reducing or eliminating the need to switch dental instruments, as is necessary with dental tools of the prior art.

A number of embodiments of the present invention have been described. Nevertheless, it will be understood that various modifications may be made without departing from the spirit and scope of the invention. Accordingly, other embodiments are within the scope of the following claims.

1. A dental instrument comprising:
an elongated body portion forming a handle for the instrument, the elongated body portion having a first end and a second end opposite the first end;
a first extension disposed at the first end, a distal end of the first extension being formed into a first tool selected from one of: a plugger, a burnisher, a carver, and an explorer; and
a second extension disposed at the first end, a distal end of the second extension being formed into a second tool selected from another of: a plugger, a burnisher, a carver, and an explorer.

2. The dental instrument of claim 1, wherein the first extension and the second extension define an included angle of between about 70 degrees to about 120 degrees.

3. The dental instrument of claim 1, further comprising:
a third extension disposed at the second end, a distal end of the third extension being formed into a third tool selected from one of: a plugger, a burnisher, a carver, and an explorer, the third tool being a different type of tool than the first and second tools.

4. The dental instrument of claim 3, wherein the third tool is a carver and the third extension includes a first portion defining a first included angle of between about 115 degrees to about 155 degrees with an axis of the elongated body portion, and a second portion defining a second included angle of about 70 degrees to about 110 degrees with the first portion.

5. The dental instrument of claim 3, further comprising:
a fourth extension disposed at the second end, a distal end of the fourth extension being formed into a fourth tool selected from one of: a plugger, a burnisher, a carver, and an explorer, the fourth tool being a different type of tool than the first, second, and third tools.

6. The dental instrument of claim 5, wherein the third and fourth extensions define an included angle of between about 70 degrees to about 120 degrees.

7. The dental instrument of claim 5, further comprising:
a fifth extension disposed at the second end, a distal end of the fifth extension being formed into a fifth tool selected from one of: a plugger, a burnisher, a carver, and an explorer.

8. The dental instrument of claim 7, wherein the third, fourth, and fifth extensions are evenly spaced about a perimeter of the body portion.

9. The dental instrument of claim 7, further comprising:
a sixth extension disposed at the first end, a distal end of the sixth extension being formed into a sixth tool selected from one of: a plugger, a burnisher, a carver, and an explorer.

10. The dental instrument of claim 1, further comprising:
a third extension disposed at the first end, a distal end of the third extension being formed into a third tool selected from one of: a plugger, a burnisher, a carver, and an explorer, the third tool being a different type of tool than the first and second tools.

11. The dental instrument of claim 10, wherein the first, second, and third extensions are evenly spaced about a perimeter of the body portion.

12. The dental instrument of claim 3, further comprising:
a fourth extension disposed at the first end, a distal end of the fourth extension being formed into a fourth tool selected from one of: a plugger, a burnisher, a carver, and an explorer, the fourth tool being a different type of tool than the first and second tools.

13. The dental instrument of claim 1, wherein the first tool is a plugger, the plugger having one of a flat end and a serrated end.

14. The dental instrument of claim 1, wherein the first tool is a carver, the carver having one of a pointed end and a round end.

15. The dental instrument of claim 1, wherein the first tool is a burnisher, the burnisher having one of a pointed end and a round end.
